(19) United States
(12) Patent Application Publication
(10) Pub. No.: US 2022/0016462 A1
(43) Pub. Date: Jan. 20, 2022

(54) COMPOSITION AND METHOD FOR EXTINGUISHING FIRE

(71) Applicant: Hiow San Choo, Klang (MY)

(72) Inventor: Hiow San Choo, Klang (MY)

(21) Appl. No.: 17/311,296

(22) PCT Filed: Sep. 4, 2020
(86) PCT No.: PCT/MY2020/050082

§ 371 Date: Jun. 4, 2021

(30) Foreign Application Priority Data
Sep. 6, 2019 (MY) PI2019005173

(51) Int. Cl. A62D 1/00; A62C 13/64

(52) U.S. Cl. CPC A62D 1/0042; A62C 13/64

(57) ABSTRACT

The present invention relates to a composition for extinguishing fire, comprising an aqueous solution of a surfactant and a deliquescent anionic salt. A method for extinguishing fire is also disclosed. The method (100) comprises mixing a surfactant and a deliquescent anionic salt in water to form an aqueous solution (110) and spreading the aqueous solution over a burning surface (120).

### FIELD OF THE INVENTION

The disclosures made herein relate generally to the field of fire fighting and more particularly to a composition and method for extinguishing fire.

### BACKGROUND OF THE INVENTION

Fire is a chemical process of combustion, wherein a material is rapidly oxidized to result in release of heat, light and one or more reaction products. During the combustion, a combustible material reacts with oxygen or oxygen-rich compound in the presence of heat sufficient to trigger the oxidation process. Under certain circumstances, fire may be undesired and uncontrollable, wherein the size and spreading rate and direction of the fire are extensive and unpredictable.

From ancient days, water has been the most frequently used fire extinguishing medium, due to its ability of rapidly cooling down a burning surface below an ignition point of burning material. As a resultant of cooling the burning surface, water is evaporated. When the water evaporates, the cooled portions of the burning surface may again be heated and start burning.

Researchers have been involved in developing fire extinguishing agents that are more effective and efficient as compared to water. U.S. Pat. No. 9,687,686 B2 discloses fire extinguishing foam containing a surface-active agent containing a substituted or unsubstituted carbohydrate or carbohydrate derivative and an oligosiloxane. Such surface-active agents facilitate formation of a closed water film on a burning liquid surface e.g. fuel, to prevent the burning liquid from turning into gaseous phase. However, it is not efficient in extinguishing fire if the burning surface is solid, rough and porous materials like wood, which prevents complete distribution of foaming on the burning surface.

Hence, there is a need for a composition and method for extinguishing fire, which is very effective and efficient in extinguishing fire on both hydrophilic and hydrophobic surfaces without foaming.

### SUMMARY OF THE INVENTION

The present invention relates to a composition for extinguishing fire, comprising an aqueous solution of a surfactant and a deliquescent anionic salt. A method for extinguishing fire is also disclosed. The method comprises mixing a surfactant and a deliquescent anionic salt in water to form an aqueous solution and spreading the aqueous solution over a burning surface.

In one embodiment, the aqueous solution includes at least 0.5% by weight of the surfactant, and the surfactant is, for example, trisiloxine-polyether modified. Preferably, the deliquescent anionic salt is calcium chloride.

The aqueous solution has extremely low surface tension (which means that water molecules have higher mobility and migrating properties) and a contact angle of 0° and so, it is very good in spreading, penetration and wetting with virtually no foaming when coming in contact with a burning surface. Therefore, the present invention is capable of blocking oxygen supply to the burning surface and rapidly and instantly reducing a surface temperature through rapid heat energy to mass (water) inter-transfer, which in turn helps in extinguishing fires more effectively & efficiently.

### BRIEF DESCRIPTION OF THE ACCOMPANYING DRAWINGS

The present invention will be fully understood from the detailed description given herein below and the accompanying drawings which are given by way of illustration only, and thus are not limitative of the present invention, wherein:

In the appended drawings:

FIG. 1 shows a flow diagram of the method for extinguishing fire, in accordance with the exemplary embodiment of the present invention.

FIG. 2 shows a schematic diagram of an assembly for extinguishing fire, in accordance with the exemplary embodiment of the present invention.

FIGS. 3A-3B show cross sectional views of the fire extinguishing device in accordance with an alternate embodiment of the present invention.

### DETAILED DESCRIPTION OF THE INVENTION

Detailed description of preferred embodiments of the present invention is disclosed herein. It should be understood, however, that the embodiments are merely exemplary of the present invention, which may be embodied in various forms. Therefore, the details disclosed herein are not to be interpreted as limiting, but merely as the basis for the claims and for teaching one skilled in the art of the invention. The numerical data or ranges used in the specification are not to be construed as limiting. The following detailed description of the preferred embodiments will now be described in accordance with the attached drawings, either individually or in combination.

Various terms as used herein are defined below. To the extent a term used in a claim is not defined below, it should be understood with the broadest definition given by persons in the pertinent art to that term as reflected in publications (e.g. dictionaries, article or published patent applications) and issued patents at the time of filing.

### Definitions

Fire extinguishing/firefighting—A process of preventing or controlling spread of and extinguishing unwanted fire in residential and commercial premises, offshore plants, forests, etc.

Composition/formulation—A mixture of two or more chemical elements or compounds. It may be in the form of powder, liquid, emulsion, solution, colloid, suspension, foam, gel and the like.

Spreading—A process of distributing a liquid over a surface/material by means of spraying, sprinkling, showering, splashing, pouring and the like.

The present invention relates to a composition for extinguishing fire and a method therefor. The composition comprises an aqueous solution of a surfactant and a deliquescent anionic salt. The aqueous solution has a very low surface tension and 0° contact angle (which means that water molecules have higher mobility and migrating properties) and is effective and efficient in spreading, penetration and wetting with virtually no foaming when coming in contact with a burning surface, and therefore blocking oxygen supply to all the dimensions of the burning surface and pores and instantly reducing the surface temperature through rapid heat energy to mass (water) inter-transfer, which in turn help in extinguishing fires more effectively and efficiently.

The surfactant is a polyether modified trisiloxane, in particular 3-(3-Hydroxypropyl)-heptamethyltrisiloxane, ethoxylated, hydroxyl terminated.

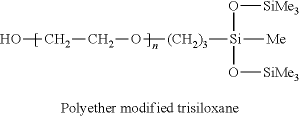

In a preferred embodiment, ingredients of the composition are mixed in a specific proportion as listed in Table 1.

TABLE 1
Preferred proportion of the ingredients of the composition

| No. | Ingredient | % by weight |
|---|---|---|
| 1 | Surfactant | 0.5 |
| 2 | Deliquescent | 5 |
| | anionic salt | |
| 2 | Water | 94.5 |

It is to be understood that the above proportion of ingredients are for experimental purpose, and the actual proportion may be varied as per requirements. Optionally, a defoaming agent e.g. silicon oil, may be included in the composition to completely avoid foaming.

Attributes (surface tension and contact angle) of two different samples, sample 1 (0.05% of polyether modified trisiloxane by weight) and sample 2 (0.10% of polyether modified trisiloxane by weight) of the present invention with respect to water and a conventional surfactant composition are shown in Table 2.

TABLE 2
Comparison of attributes of present invention with respect
to water and a conventional Surfactant composition

| | Surface tension | | | | | | |
|---|---|---|---|---|---|---|---|
| Fire | (millinewton | | | | | | |
| extinguishing | per meter | Contact angle (°) | | | | | |
| composition | (mN/m)) | Cole | Kale | Tomato | Spinach | Shallot | Celery |
| Water | 72.4 | 39.6 | 93.6 | 49.3 | 41.8 | 130.2 | 36.5 |
| Conventional | 29.8 | 21.9 | 19.3 | 22.7 | 36.1 | 23.5 | 30.7 |
| Surfactant | | | | | | | |
| composition | | | | | | | |
| Sample 1 | 22.6 | 0.0 | 0.0 | 0.0 | 0.0 | 0.0 | 0.0 |
| Sample 2 | 22.2 | 0.0 | 0.0 | 0.0 | 0.0 | 0.0 | 0.0 |

mN/m—millinewtons per meter

From the above results, it is clear that the present invention has excellent spreading, penetration and wetting capabilities with virtually no foaming when coming in contact with a burning surface, which helps in extinguishing fires more effectively and efficiently.

Additionally, the anionic salt increases boiling point of the aqueous solution, thus delaying the vaporization (wetting) of the water. Even after complete vaporization of the water, a thin film of deliquescent anionic crystal is formed on the burning surface, which continues blocking of oxygen supply to the burning surface. Thus, the present invention is effective in extinguishing fires on both hydrophilic surfaces as well as hydrophobic surfaces.

Additionally, when the aqueous solution is dried due to the heat from the burning surface, fine deliquescent anionic salt crystals absorb water resulting from combustion of hydrocarbon, which will turn the crystals into aqueous solution again that will continue wetting the burning surface. Furthermore, the composition does not include any toxic or heavy metal compounds, and thus is environment-friendly. The complete fire extinguishing process using the composition is explained in detail in the forthcoming paragraphs.

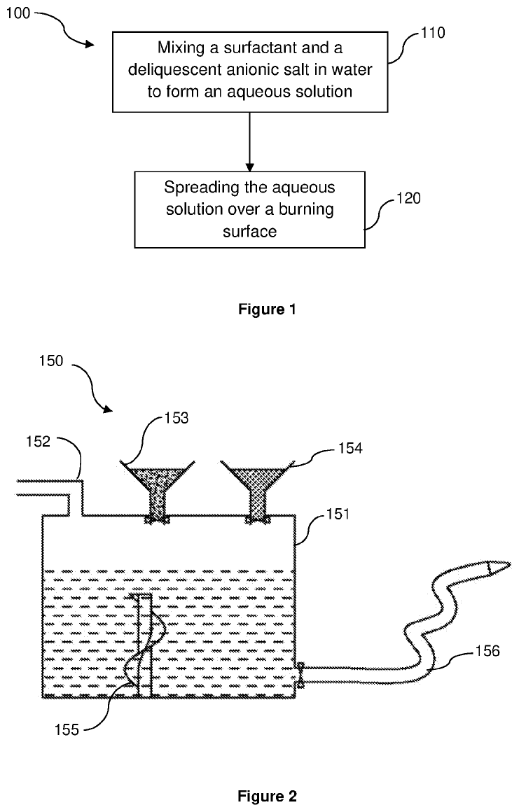

FIG. 1 shows a flow diagram of the method for extinguishing fire, in accordance with an exemplary embodiment of the present invention. The method (100) comprises the steps of: mixing a surfactant and deliquescent anionic salt in water to form an aqueous solution (110) and spreading the aqueous solution over a burning surface (120). Preferably, the surfactant is polyether modified trisiloxane and the deliquescent anionic salt is calcium chloride, wherein the proportion of the surfactant, deliquescent anionic salt and water in the aqueous solution are as per Table 1.

More preferably, the polyether modified trisiloxane is 3-(3-Hydroxypropyl)-heptamethyltrisiloxane, ethoxylated, hydroxyl terminated. By this way, surface tension of the aqueous solution is minimized, and thus improving spreading, penetration and wetting capabilities of the aqueous solution without/with minimal foaming when coming in contact with all dimensions of the burning surface and porous materials, and therefore blocking oxygen supply to the burning surface and rapidly reducing a surface temperature, which in turn help in extinguishing fires more effectively and efficiently.

The deliquescent anionic salt can be a mono-valence anionic salt, di-valence anionic salt or any other salt. The mixture of the surfactant and the deliquescent anionic salt reduces the surface tension of the aqueous solution to enable the aqueous solution to spread quickly and uniformly over the burning surface to block oxygen supply to the burning surface.

In addition to solid surfaces, the present invention may also be applied for extinguishing fire over molten materials for e.g. plastics, rubber and wax, or any other fires that need to be extinguished with minimal or no foam such as forest fires.

The core idea of this invention is which able to turn the water into fire extinguishing medium in mass scale just by simple addition of some chemicals in the fire spot, especially suitable to those premises which well equipped with fire water pool, hose, firewater sprinklers.

In a preferred embodiment, the aqueous solution is spread over the burning surface using a fire extinguishing device, wherein the aqueous solution is filled in the fire extinguishing device and is discharged from the fire extinguishing device to spread the aqueous solution over the burning surface. Preferably, the fire extinguishing device is a hand-held cylindrical pressure vessel, wherein the aqueous solution is pressurized in the hand-held cylindrical pressure vessel while filling the aqueous solution in the hand-held cylindrical pressure vessel. More preferably, the aqueous solution is pressurized using a gas non-reactive to the aqueous solution and/or an inner surface of the hand-held cylindrical pressure vessel such as nitrogen.

FIG. 2 shows a schematic diagram of an assembly for extinguishing fire, in accordance with the exemplary embodiment of the present invention. The assembly (150) includes a tank (151) with an inlet (152) for receiving water or any conventional fire hydrant. A surfactant container (153) and a salt container (154) are connected to the tank (151), wherein a control valve (not shown) is connected between the tank (151) and each of the containers (153, 154) such that flow of surfactant and anionic salt into the tank (151) is controlled by opening/closing the valves.

A mixing mechanism (155) is provided in the form of a helical conveyor for mixing the contents within the tank (151), such that when surfactant and the anionic salt are transferred from the containers (153, 154) to the tank (150), the mixing mechanism (155) is operated to dissolve the transferred contents in the water. Furthermore, a discharge hose (156) is connected to the tank (150) through another control valve (not shown), such that when the control valve is opened, the water in the tank (151) is discharged through the hose (156) and directed to a burning surface. Preferably, the control valves and the mixing mechanism (155) are operated through any conventional electronic control unit.

Alternatively, the control valves and the mixing mechanism (155) may also be manually operated for preparing the composition for extinguishing fire and spreading the composition over the burning surface. Furthermore, the assembly (150) can be configured to be fitted to a firefighting vehicle, wherein a cartridge of the surfactant and the deliquescent anionic salt are dropped into a water tank of the vehicle and a motorized arm may be used for mixing the contents therein. Alternatively, mixing of the contents is also possible by waves formed in the tank due to while the vehicle is in movement.

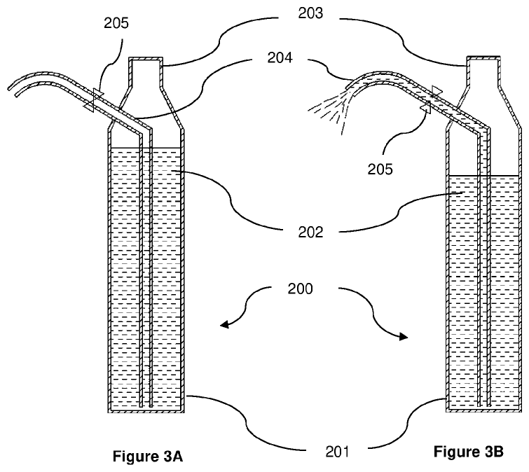

FIGS. 3A-3B show cross sectional views of the fire extinguishing device in accordance with an alternate embodiment of the present invention. The fire extinguishing device (200) comprises a tank (201) containing a composition (202) for extinguishing fire, wherein the composition (202) is an aqueous solution of a surfactant and a deliquescent anionic salt. Preferably, the surfactant is polyether modified trisiloxane and the deliquescent anionic salt is calcium chloride, wherein the proportion of the surfactant, deliquescent anionic salt and water in the aqueous solution are as per Table 1.

The fire extinguishing device (200) is a hand-held cylindrical pressure vessel, wherein a closure (203) forms an air-tight sealing with the tank (201) when closed. The aqueous solution is pressurized in the hand-held cylindrical pressure vessel using a gas non-reactive to the aqueous solution and an inner surface of the tank (201), preferably nitrogen gas. A discharge pipe (204) is fixed to the tank (201) for discharging the aqueous solution, wherein an inlet end of the discharge pipe (204) is positioned near a bottom of the tank (201) and an outlet end of the discharge pipe (204) is positioned outside the tank (201). A valve (205) is fixed near the outlet end of the discharge pipe (204), such that the valve (205) can be easily opened/closed while directing the outlet end towards a burning surface. The aqueous solution is pressurized to a level that allows discharge of the aqueous solution when the valve (205) is opened, as shown in FIG. 2B.

The present invention was tested at TAIWAN FIRE TECHNOLOGY FOUNDATION, wherein a hand-held cylindrical pressure vessel is filled with the composition of the above mentioned proportion and pressurized using nitrogen gas, while another hand-held cylindrical pressure vessel is filled with tap water and pressurized with nitrogen gas. Both the pressure vessels are used to extinguish an A-2 fire model as per the Fire Extinguishers recognized standard 1.4, wherein the present invention successfully extinguished the fire, while the tap water failed to extinguish the fire.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed. The use of the expression “at least” or “at least one” suggests the use of one or more elements, as the use may be in one of the embodiments to achieve one or more of the desired objects or results.

1. A composition for extinguishing fire, comprising an aqueous solution of a surfactant and a deliquescent anionic salt, characterized in that said surfactant is polyether modified trisiloxane.

2. The composition as claimed in claim 1, wherein said aqueous solution includes at least 0.5% by weight of said surfactant.

3. The composition as claimed in claim 1, wherein said polyether modified trisiloxane is 3-(3-Hydroxypropyl)-heptamethyltrisiloxane, ethoxylated, hydroxyl terminated.

4. The composition as claimed in claim 1, wherein said anionic salt is a mono-valence anionic salt.

5. The composition as claimed in claim 1, wherein said anionic salt is a di-valence anionic salt.

6. The composition as claimed in claim 5, wherein said di-valence anionic salt is calcium chloride.

7. The composition as claimed in claim 1, wherein said aqueous solution includes 5% by weight of said deliquescent anionic salt.

8. The composition as claimed in claim 1, wherein said burning surface is a hydrophilic surface.

9. The composition as claimed in claim 1, wherein said burning surface is a hydrophobic surface.

10. A method for extinguishing fire, comprising the step of: mixing a surfactant and a deliquescent anionic salt in water to form an aqueous solution and spreading said aqueous solution over a burning surface characterized in that said surfactant is polyether modified trisiloxane.

11. The method as claimed in claim 10, wherein said aqueous solution includes at least 0.5% by weight of said surfactant.

12. The method as claimed in claim 10, wherein said polyether modified trisiloxane is 3-(3-Hydroxypropyl)-heptamethyltrisiloxane, ethoxylated, hydroxyl terminated.

13. The method as claimed in claim 10, wherein said aqueous solution includes at least 5% by weight of said deliquescent anionic salt.

14. The method as claimed in claim 10, wherein said anionic salt is a mono-valence anionic salt.

15. The method as claimed in claim 10, wherein said anionic salt is a di-valence anionic salt.

16. The method as claimed in claim 10, wherein said anionic salt is at least one of sodium chloride and calcium chloride.

17. The method as claimed in claim 10, wherein said step of spreading said aqueous solution over said burning surface includes filling a fire extinguishing device with said aqueous solution and discharging said aqueous solution from said fire extinguishing device to spread said aqueous solution over said burning surface.

18. The method as claimed in claim 10, wherein said burning surface is a hydrophilic surface.

19. The method as claimed in claim 10, wherein said burning surface is a hydrophobic surface.
